(19) United States
(12) Patent Application Publication
(10) Pub. No.: US 2025/0305498 A1
(43) Pub. Date: Oct. 2, 2025

(54) SCROLL ELECTRIC COMPRESSOR

(71) Applicant: KABUSHIKI KAISHA TOYOTA JIDOSHOKKI, Aichi (JP)

(72) Inventors: Shiori YAMAMOTO, Aichi (JP); Takuro YAMASHITA, Aichi (JP); Taku ADANIYA, Aichi (JP); Kensuke IKAI, Aichi (JP); Masaki OTSUBO, Aichi (JP)

(73) Assignee: KABUSHIKI KAISHA TOYOTA JIDOSHOKKI, Aichi (JP)

(21) Appl. No.: 19/071,883

(22) Filed: Mar. 6, 2025

(30) Foreign Application Priority Data
Mar. 28, 2024 (JP) 2024-054708

(51) Int. Cl. F04C 18/02

(52) U.S. Cl. CPC F04C 18/0215; F04C 2240/30; F04C 2240/40; F04C 2240/60

(57) ABSTRACT

A scroll electric compressor includes a rotary shaft, a motor including a rotor, a compression part, a housing, a balance weight, a plurality of stacking steel plates stacked in the axial direction to form the rotor, the rotor having a plurality of fluid flow holes, the stacking steel plates each having a plurality of flow holes and being stacked so that the flow holes form the fluid flow holes. The rotor has a balance adjustment portion that cancels a centrifugal force generated by the balance weight. The stacking steel plates have weight portions that are formed by reducing a radial dimension of at least one of the flow holes as compared to a radial dimension of the other of the flow holes that overlaps the balance weight in the axial direction, and the balance adjustment portion is formed by stacking the weight portions in the axial direction.

### CROSS-REFERENCE TO RELATED APPLICATION

This application claims priority to Japanese Patent Application No. 2024-054708 filed on Mar. 28, 2024, the entire disclosure of which is incorporated herein by reference.

The present disclosure relates to a scroll electric compressor.

### BACKGROUND ART

For example, Japanese Patent Application Publication No. 2021-36133 discloses a scroll electric compressor in which a balance weight is integrated into a drive shaft as a rotary shaft and a rotor weight is integrated into an electric motor. When such a scroll electric compressor is operated, a centrifugal force generated by orbital motion of a movable scroll as an orbiting scroll acts on the drive shaft, and a centrifugal force generated by the balance weight acts on the drive shaft. In addition, when the scroll electric compressor is operated, a centrifugal force generated by the rotor weight also acts on the drive shaft through a rotor. In the scroll electric compressor, the centrifugal force by the movable scroll acting on the drive shaft is cancelled with the centrifugal force generated by the balance weight and the centrifugal force generated by the rotor weight.

For the scroll electric compressor configured to cancel the centrifugal force generated by the movable scroll acting on the drive shaft, there has been a demand for reduction of the number of parts and downsizing the scroll electric compressor in an axial direction.

### SUMMARY

In accordance with an aspect of the present disclosure, there is provided a scroll electric compressor including: a rotary shaft; a motor including a rotor fixed to the rotary shaft, and a stator having a cylindrical shape and surrounding the rotor; a compression part configured to compress fluid with rotation of the rotary shaft; a housing accommodating the motor and the compression part; the compression part including a fixed scroll and an orbiting scroll configured to make orbital motion with the rotation of the rotary shaft disposed in the housing, the fixed scroll and the orbiting scroll cooperating to form a compression chamber in which the fluid is compressed; the housing having a motor housing accommodating the motor, a compression part housing accommodating the compression part, a shaft support housing rotatably supporting the rotary shaft between the rotor and the orbiting scroll; a balance weight fixed to the rotary shaft, extending in a radial direction of the rotary shaft, and facing the rotor and the shaft support housing in an axial direction of the rotary shaft; a plurality of stacking steel plates stacked in the axial direction to form the rotor; the rotor having a plurality of fluid flow holes through which the fluid flows, the fluid flow holes being disposed in a circumferential direction of the rotor and extending though the rotor in the axial direction; and the stacking steel plates each having a plurality of flow holes, the stacking steel plates being stacked so that the flow holes form the fluid flow holes. The rotor has a balance adjustment portion at a position where the balance adjustment portion cancels a centrifugal force generated by the balance weight. The stacking steel plates have weight portions, respectively, that are formed by reducing a radial dimension of at least one of the flow holes as compared to a radial dimension of the other of the flow holes that overlaps the balance weight in the axial direction, and the balance adjustment portion is formed by stacking the weight portions in the axial direction.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of a scroll electric compressor according to a first embodiment;

FIG. 2 is an exploded perspective view illustrating a rotor;

FIG. 3 is a view of the rotor as viewed in an axial direction;

FIG. 4 is a view of a rotor body as viewed in the axial direction;

FIG. 5 is a cross-sectional view of a rotor according to a second embodiment; and

FIG. 6 is a view of a stacking steel plate according to the second embodiment.

### DETAILED DESCRIPTION OF THE EMBODIMENTS

### First Embodiment

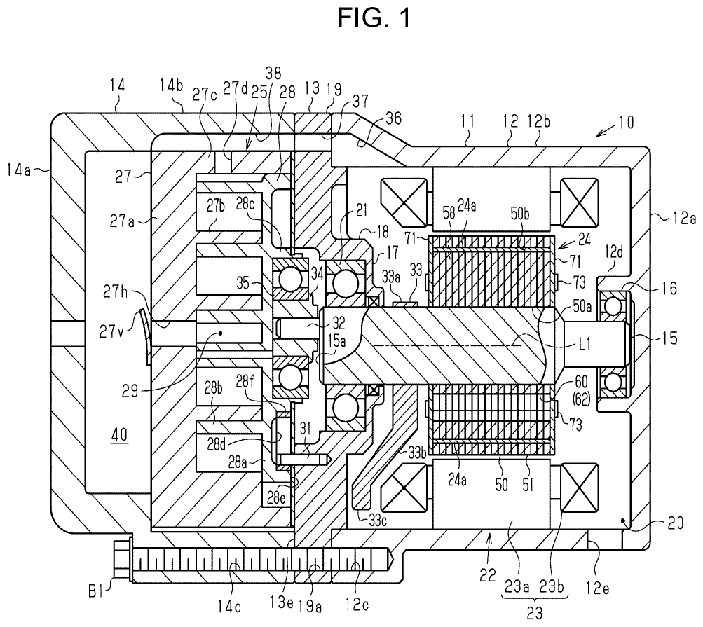

The following will describe a scroll electric compressor according to a first embodiment with reference to FIGS. 1 to 4.

### Overall Configuration of Scroll Electric Compressor

As illustrated in FIG. 1, a scroll electric compressor 10 includes a housing 11, a rotary shaft 15, a compression part 25, a motor 22, and a balance weight 33. The housing 11 accommodates the rotary shaft 15, the compression part 25, the motor 22, and the balance weight 33.

### Housing

The housing 11 includes a motor housing 12, a shaft support housing 13, and a compression part housing 14. The motor housing 12, the shaft support housing 13, and the compression part housing 14 are made of metal, for example, aluminum.

The motor housing 12 has an end wall 12a and a peripheral wall 12b extending in a tubular shape from an outer peripheral edge of the end wall 12a toward the shaft support housing 13. An axial direction of the peripheral wall 12b coincides with an axial direction of the rotary shaft 15. The peripheral wall 12b has an internally threaded hole 12c on a side opposite from the end wall 12a. In addition, an inlet port 12e through which refrigerant as fluid is drawn is formed in the peripheral wall 12b on the end wall 12a side.

The motor housing 12 has a boss 12d that protrudes from an inner surface of the end wall 12a. A first end portion of the rotary shaft 15 is inserted into the boss 12d, and a bearing 16 is disposed between an inner peripheral surface of the boss 12d and an outer peripheral surface of the first end portion of the rotary shaft 15.

The shaft support housing 13 has a flange 19 having a disk shape, a tubular portion 18 protruding from an inner peripheral edge of the flange 19, and an end wall 17 extending in a circular plate shape from the inner peripheral edge of the tubular portion 18. An outer peripheral portion of the flange 19 is held by the motor housing 12 and the compression part housing 14 from opposite sides of the flange 19 in the axial direction of the rotary shaft 15. A bolt insertion hole 19a is formed in part of the outer peripheral portion of the flange 19.

A second end portion of the rotary shaft 15 is inserted through the center of the end wall 17. A bearing 21 is disposed between an outer peripheral surface of the second end portion of the rotary shaft 15 and an inner peripheral surface of the tubular portion 18. The rotary shaft 15 is rotatably supported by the housing 11 via the bearings 16, 21. The rotary shaft 15 has an eccentric shaft 32 protruding from an end surface 15a at the second end portion. The eccentric shaft 32 is integrally formed with the rotary shaft 15. The eccentric shaft 32 extends from the rotary shaft 15 at a position eccentric to an axial line L1 of the rotary shaft 15 toward the compression part 25.

The motor housing 12 and the shaft support housing 13 cooperate to define a motor accommodation chamber 20. The motor 22 is accommodated in the motor accommodation chamber 20, and hence the housing 11. In addition, refrigerant is drawn into the motor accommodation chamber 20 through the inlet port 12e.

The compression part housing 14 has an end wall 14a and a peripheral wall 14b extending in a tubular shape from an outer peripheral edge of the end wall 14a toward the shaft support housing 13. An axial direction of the peripheral wall 14b coincides with the axial direction of the rotary shaft 15. The peripheral wall 14b has a bolt insertion hole 14c on a side opposite from the end wall 14a. A bolt B1 inserted through the bolt insertion hole 14c of the compression part housing 14 and the bolt insertion hole 19a of the flange 19 is screwed into the internally threaded hole 12c of the motor housing 12. Thus, the motor housing 12, the shaft support housing 13, and the compression part housing 14 are connected to form the housing 11.

A plurality of first grooves 36 is formed in a portion of an inner peripheral surface of the peripheral wall 12b of the motor housing 12. In addition, first holes 37 each connected to its associated one of the first grooves 36 are formed in the outer peripheral portion of the flange 19 of the shaft support housing 13. Furthermore, a plurality of second grooves 38 each connected to its associated one of the first holes 37 is formed in a portion of an inner peripheral surface of the peripheral wall 14b of the compression part housing 14. It is noted that, for convenience of illustration, only one each of the first grooves 36, the first holes 37, and the second grooves 38 is illustrated in FIG. 1.

In the scroll electric compressor 10, refrigerant drawn into the motor accommodation chamber 20 through the inlet port 12e passes through the motor 22, then through the first grooves 36, the first holes 37, and the second grooves 38, and is introduced into the compression part 25.

A discharge chamber 40 is defined in the housing 11. The discharge chamber 40 is defined by the compression part housing 14 and the compression part 25. The discharge chamber 40 is in communication with a discharge port 27h of the compression part 25. Refrigerant compressed by the compression part 25 is discharged to the discharge chamber 40 through the discharge port 27h.

### Motor

The motor 22 is accommodated in the motor housing 12. The motor 22 rotates the rotary shaft 15. The motor 22 includes a rotor 24 fixed to the rotary shaft 15, and a stator 23 having a cylindrical shape and surrounding the rotor 24. The rotor 24 rotates together with the rotary shaft 15. The stator 23 surrounds the rotor 24 in a circumferential direction of the rotary shaft 15, and is fixed to the peripheral wall 12b.

The stator 23 includes a stator core 23a having a tubular shape and fixed to the inner peripheral surface of the peripheral wall 12b of the motor housing 12, and a coil 23b wound around the stator core 23a. The rotor 24 rotates with electric power controlled by a drive circuit (not illustrated) supplied to the coil 23b, which causes the rotary shaft 15 to rotate together with the rotor 24. The rotor 24 will be described in detail later.

### Compression Part

The compression part 25 is driven by rotation of the rotary shaft 15 to compress refrigerant. The compression part 25 includes a fixed scroll 27 and an orbiting scroll 28 that makes orbital motion with rotation of the rotary shaft 15, which are disposed in the housing 11. The fixed scroll 27 and the orbiting scroll 28 cooperate to form therebetween a compression chamber 29 in which refrigerant is compressed. The fixed scroll 27 and the orbiting scroll 28 are disposed inside the peripheral wall 14b of the compression part housing 14. Thus, the compression part housing 14 accommodates the compression part 25.

The fixed scroll 27 is fixed to the compression part housing 14 and disposed in the housing 11. The fixed scroll 27 has a fixed scroll base plate 27a, a fixed scroll spiral wall 27b, and a fixed scroll outer peripheral wall 27c. The fixed scroll base plate 27a has a circular plate shape. The discharge port 27h is formed at the center of the fixed scroll base plate 27a. The fixed scroll spiral wall 27b extends from the fixed scroll base plate 27a toward the shaft support housing 13. The fixed scroll outer peripheral wall 27c extends in a cylindrical shape from an outer peripheral portion of the fixed scroll base plate 27a toward the shaft support housing 13. The fixed scroll outer peripheral wall 27c surrounds the fixed scroll spiral wall 27b. An intake port 27d is formed in the fixed scroll outer peripheral wall 27c.

The orbiting scroll 28 is disposed inside the compression part housing 14, and connected to the rotary shaft 15. The orbiting scroll 28 includes an orbiting scroll base plate 28a and an orbiting scroll spiral wall 28b. The orbiting scroll base plate 28a has a circular plate shape. The orbiting scroll base plate 28a faces the fixed scroll base plate 27a and the shaft support housing 13 in the axial direction of the rotary shaft 15. Thus, the shaft support housing 13 rotatably supports the rotary shaft 15 between the rotor 24 and the orbiting scroll 28. The orbiting scroll spiral wall 28b extends from the orbiting scroll base plate 28a towards the fixed scroll base plate 27a. The orbiting scroll spiral wall 28b meshes with the fixed scroll spiral wall 27b. The orbiting scroll spiral wall 28b is positioned inside the fixed scroll outer peripheral wall 27c. A distal end surface of the fixed scroll spiral wall 27b is in contact with the orbiting scroll base plate 28a, and a distal end surface of the orbiting scroll spiral wall 28b is in contact with the fixed scroll base plate 27a. The fixed scroll base plate 27a, the fixed scroll spiral wall 27b, the orbiting scroll base plate 28a, and the orbiting scroll spiral wall 28b cooperate to define a compression chamber 29 in which refrigerant is compressed.

The orbiting scroll base plate 28a has a boss 28c having a cylindrical shape on an end surface 28e opposite from the fixed scroll base plate 27a. An axial direction of the boss 28c coincides with the axial direction of the rotary shaft 15. A plurality of recesses 28d is formed in the end surface 28e of the orbiting scroll base plate 28a around the boss 28c. The recesses 28d are disposed at predetermined intervals in the circumferential direction of the rotary shaft 15. Ring members 28f each having a ring shape are fitted into the recesses 28d, respectively. In addition, pins 31 to be inserted in the ring members 28f, respectively, protrude from an end faces 13e of the shaft support housing 13 on the compression part housing 14 side.

The fixed scroll base plate 27a has a valve mechanism 27v mounted on a surface opposite to the orbiting scroll 28. The valve mechanism 27v opens and closes the discharge port 27h.

The eccentric shaft 32 protrudes from the end surface 15a of the rotary shaft 15 toward the orbiting scroll 28 and is inserted into the boss 28c. The orbiting scroll 28 is supported by the eccentric shaft 32 via a bushing 34 and a bearing 35 so as to be rotatable relative to the eccentric shaft 32. The rotation of the rotary shaft 15 is transmitted to the orbiting scroll 28 through the eccentric shaft 32, the bushing 34, and the bearing 35. This may cause the orbiting scroll 28 to rotate; however, the pins 31 in contact with their associated inner peripheral surfaces of the ring members 28f prevent the orbiting scroll 28 from rotating, and only allows the orbiting scroll 28 to make orbital motion. Thus, the orbiting scroll 28 makes orbital motion while the orbiting scroll spiral wall 28b is in contact with the fixed scroll spiral wall 27b, which reduces the volume of the compression chamber 29 to compress refrigerant.

In the scroll electric compressor 10, refrigerant drawn into the motor accommodation chamber 20 through the inlet port 12e passes through the motor 22, then through the first grooves 36, the first holes 37, and the second grooves 38, and is introduced into a suction chamber (not illustrated) through the intake port 27d. Refrigerant drawn into the suction chamber is drawn into the compression chamber 29 and compressed in the compression chamber 29 with orbital motion of the orbiting scroll 28. Refrigerant compressed in the compression chamber 29 pushes open the valve mechanism 27v, and is discharged to the discharge chamber 40 through the discharge port 27h.

### Balance Weight

The balance weight 33 is fixed to the rotary shaft 15 and rotates together with the rotary shaft 15. The balance weight 33 faces the rotor 24 and the shaft support housing 13 in the axial direction of the rotary shaft 15. In addition, the balance weight 33 is disposed at a position opposite from the eccentric shaft 32 across the axial line L1 in the rotary shaft 15 and at a position eccentric to the axial line L1. The balance weight 33 has a substantially rectangular plate shape extending in a radial direction of the rotary shaft 15. The balance weight 33 has a proximal end portion 33a, an inclined portion 33b, and a distal end portion 33c. The proximal end portion 33a is fixed to the rotary shaft 15. The inclined portion 33b extends from the proximal end portion 33a so as to be inclined to approach the shaft support housing 13. The distal end portion 33c extends generally perpendicularly to the radial direction of the rotary shaft 15 from the inclined portion 33b. The inclined portion 33b and the distal end portion 33c of the balance weight 33 extend away from the eccentric shaft 32 in the radial direction of the rotary shaft 15.

The balance weight 33 reduces an amount of unbalance of the orbiting scroll 28 by cancelling the centrifugal force acting on the orbiting scroll 28 during the orbital motion of the orbiting scroll 28. A shape of the balance weight 33 may be changed to any desired shape as long as the balance weight 33 can cancel the centrifugal force acting on the orbiting scroll 28 during the orbital motion of the orbiting scroll 28.

### Rotor

As illustrated in FIGS. 1 and 3, the rotor 24 includes a rotor body 50, a pair of holding plates 71, a plurality of coupling pins 73, and a plurality of permanent magnets 24a. The axial directions of the rotor 24 and the rotor body 50 coincide with the axial direction of the rotary shaft 15, and the radial directions of the rotor 24 and the rotor body 50 coincide with the radial direction of the rotary shaft 15.

The rotor body 50 has a shaft hole 50a through which the rotary shaft 15 is inserted, a plurality of magnet holes 50b in which the permanent magnets 24a are inserted, a plurality of pin holes 50c in which coupling pins 73 are inserted, and a plurality of fluid flow holes 60 through which refrigerant flows. The shaft hole 50a, the magnet holes 50b, the pin holes 50c, and the fluid flow holes 60 extend through the rotor body 50 in the axial direction. The magnet holes 50b, the pin holes 50c, and the fluid flow holes 60 each are disposed in the circumferential direction of the rotor 24.

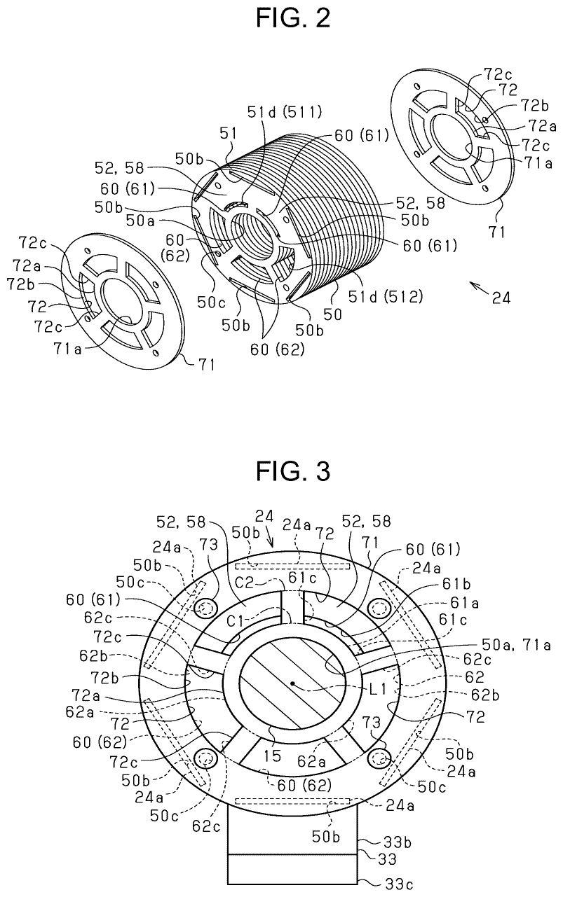

As illustrated in FIGS. 2 and 3, the shaft hole 50a is formed at the center of the rotor body 50. The magnet holes 50b are formed in a peripheral portion of the rotor body 50. The magnet holes 50b are formed at regular intervals in a circumferential direction of the rotor body 50. The number of permanent magnets 24a and the number of magnet holes 50b in the rotor body 50 can be changed as appropriate. The pin holes 50c are disposed inside a portion of the rotor body 50 where the magnet holes 50b are formed in the radial direction of the rotor body 50. The pin holes 50c are formed at regular intervals in the circumferential direction of the rotor body 50. The number of pin holes 50c formed in the rotor body 50 can be changed as appropriated according to the number of coupling pins 73.

The fluid flow holes 60 includes two first fluid flow holes 61 and three second fluid flow holes 62. It is noted that, in FIG. 3, outer shapes of the second fluid flow holes 62 match outer shapes of introduction holes 72 of holding plates 71, which will be described later, so that the second fluid flow holes 62 are indicated by dashed lines. The two first fluid flow holes 61 do not overlap the proximal end portion 33a of the balance weight 33 in the axial direction of the rotary shaft 15. In addition, one of the second fluid flow holes 62 disposed in the middle of the three second fluid flow holes 62 entirely overlaps the inclined portion 33b of the balance weight 33, and the other two second fluid flow holes 62 disposed on opposite sides of the fluid flow hole in the middle partially overlap the inclined portion 33b of the balance weight 33, in the axial direction of the rotary shaft 15.

The two first fluid flow holes 61 and the three second fluid flow holes 62 are disposed at regular intervals around the shaft hole 50a. In the following, the rotor body 50 as viewed from one axial end is referred to as an axial view. In the axial view, the first fluid flow holes 61 and the second fluid flow holes 62 each have an elongated hole shape extending in an arc shape in the circumferential direction of the rotor body 50. In addition, the first fluid flow holes 61 and the second fluid flow holes 62 each extend through the rotor body 50 entirely in the axial direction.

Each of the first fluid flow holes 61 is defined by a first inner arc surface 61a corresponding to a radially inner surface of the fluid flow hole, a first outer arc surface 61b corresponding to a radially outer surface of the fluid flow hole, and a pair of first side surfaces 61c. The first inner arc surface 61a is positioned inside the first outer arc surface 61b in the radial direction, and a dimension of the first inner arc surface 61a in the circumferential direction of the rotor body 50 is smaller than that of the first outer arc surface 61b. One of the pair of first side surfaces 61c connects one end of the first inner arc surface 61a to one end of the first outer arc surface 61b, and the other of the pair of the first side surfaces 61c connects the other end of the first inner arc surface 61a to the other end of the first outer arc surface 61b.

Each of the second fluid flow holes 62 has a second inner arc surface 62a corresponding to a radially inner surface of the fluid flow hole, a second outer arc surface 62b corresponding to a radially outer surface of the fluid flow hole, and a pair of second side surfaces 62c. The second inner arc surface 62a is positioned inside the second outer arc surface 62b in the radial direction, and a dimension of the second inner arc surface 62a in the circumferential direction of the rotor body 50 is smaller than that of the second outer arc surface 62b. One of the pair of second side surfaces 62c connects one end of the second inner arc surface 62a to one end of the second outer arc surface 62b, and the other of the pair of the second side surfaces 62c connects the other end of the second inner arc surface 62a to the other end of the second outer arc surface 62b.

In the axial view of the rotor body 50, the first inner arc surface 61a and the second inner arc surface 62a each are positioned on an arc of a first imaginary circle C1. The first imaginary circle C1 and the shaft hole 50a are concentric circles with the axial line L1 of the rotary shaft 15 as the center.

In addition, in the axial direction view of the rotor body 50, the three second outer arc surfaces 62b each are positioned on an arc of a second imaginary circle C2, which is larger in diameter than the first imaginary circle C1. The second imaginary circle C2, the shaft hole 50a and the first imaginary circle C1 are concentric circles with the axial line L1 of the rotary shaft 15 as the center. The two first fluid flow holes 61 are positioned inside the second imaginary circle C2 in the radial direction. The two first fluid flow holes 61 and the three second fluid flow holes 62 each are positioned on the arc of the first imaginary circle C1.

A dimension of each of the first side surfaces 61c in the radial direction of the rotor body 50 is smaller than that of each of the second side surfaces 62c in the radial direction of the rotor body 50. Therefore, a dimension of the first outer arc surface 61b in the circumferential direction of the rotor body 50 is smaller than that of the second outer arc surface 62b in the circumferential direction of the rotor body 50.

Portions of the rotor body 50 outside the first fluid flow holes 61 in the radial direction form balance adjustment portions 58. The balance adjustment portions 58 are formed in the rotor body 50 by reducing the dimension of the first fluid flow holes 61 in the radial direction in the rotor 24, as compared to the second fluid flow holes 62. In other words, the balance adjustment portions 58 each are formed in a portion where a radial dimension of each of the first fluid flow holes 61 is reduced as compared to a radial dimension of each of the second fluid flow holes 62 which overlaps the balance weight 33 in the axial direction.

The radial dimensions of the balance adjustment portions 58 are greater than radial dimension of portions outside the second fluid flow holes 62. Therefore, a weight of each of the balance adjustment portions 58 is greater than a portion of the rotor body 50 outside the second fluid flow holes 62 in the radial direction. The first fluid flow holes 61 positioned in portions of the rotor body 50 inside the balance adjustment portions 58 in the radial direction are positioned inside relative to the second fluid flow holes 62 in the radial direction.

The center of gravity of the rotor body 50 is positioned closer to the two first fluid flow holes 61 than the axial line L1 of the rotary shaft 15 in the radial direction. In detail, the center of gravity of the rotor body 50 is positioned opposite from the inclined portion 33b and the distal end portion 33c of the balance weight 33 across the axial line L1. Thus, the rotor 24 has the balance adjustment portions 58 provided at positions in the circumferential direction of the rotor 24 that adjusts the centrifugal force generated by the balance weight 33.

As illustrated in FIG. 2, the rotor body 50 of the rotor 24 is formed by stacking a plurality of adjustment steel plates 51, corresponding to stacking steel plates, in the axial direction of the rotary shaft 15. A radial direction of each of the adjustment steel plates 51 corresponds to the radial direction of the rotary shaft 15.

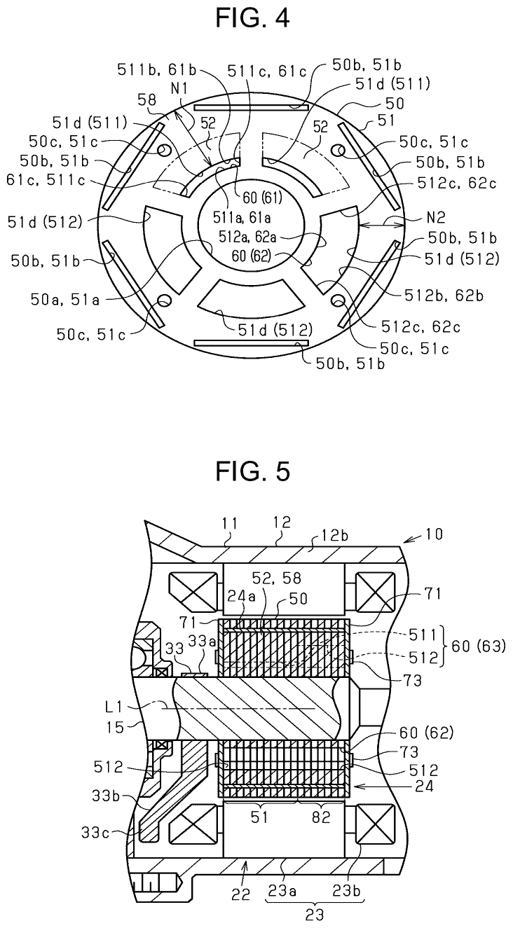

As illustrated in FIG. 4, the adjustment steel plates 51 each have a shaft hole forming hole 51a forming the shaft hole 50a, a plurality of magnet hole forming holes 51b forming the magnet holes 50b, a plurality of pin hole forming holes 51c forming the pin holes 50c, and a plurality of flow holes 51d forming the fluid flow holes 60. Each of the shaft hole forming hole 51a, the magnet hole forming holes 51b, the pin hole forming holes 51c, and the flow holes 51d extends through each of the adjustment steel plates 51 in a thickness direction thereof.

The shaft hole forming hole 51a is formed in the center of each of the adjustment steel plates 51. The magnet hole forming holes 51b are formed in a peripheral portion of each of the adjustment steel plates 51. The magnet hole forming holes 51b are formed at regular intervals in a circumferential direction of each of the adjustment steel plates 51. The pin hole forming holes 51c are disposed inside a portion of each of the adjustment steel plates 51 where the magnet hole forming holes 51b are formed in the radial direction of each of the adjustment steel plates 51. The pin hole forming holes 51c are formed at regular intervals in the circumferential direction of each of the adjustment steel plates 51.

The flow holes 51d include two first flow holes 511 and three second flow holes 512. The two first flow holes 511 and the three second flow holes 512 are disposed at regular intervals around the shaft hole forming hole 51a. As viewed in the thickness direction of the adjustment steel plates 51, the first flow holes 511 and the second flow holes 512 each have an elongated hole shape extending in an arc shape in the circumferential direction of each of the adjustment steel plates 51.

Each of the first flow holes 511 has a first inner edge portion 511a forming the first inner arc surface 61a, a first outer edge portion 511b forming the first outer arc surface 61b, and a pair of first side edge portions 511c forming of the pair of first side surfaces 61c. The first inner edge portion 511a is disposed inside the first outer edge portion 511b in the radial direction of each of the adjustment steel plates 51, and a dimension of the first inner edge portion 511a in the circumferential direction of each of the adjustment steel plates 51 is smaller than that of the first outer edge portion 511b. One of the pair of first side edge portions 511c connects one end of the first inner edge portion 511a to one end of the first outer edge portion 511b, and the other of the pair of the first side edge portions 511c connects the other end of the first inner edge portion 511a to the other end of the first outer edge portion 511b. Then, the first fluid flow holes 61 are formed of the first flow holes 511 formed in the adjustment steel plates 51 stacked in the axial direction of the rotary shaft 15.

Each of the second flow holes 512 has a second inner edge portion 512a forming the second inner arc surface 62a, a second outer edge portion 512b forming the second outer arc surface 62b, and a pair of second side edge portions 512c forming of the pair of second side surfaces 62c. The second inner edge portion 512a is disposed inside the second outer edge portion 512b in the radial direction of each of the adjustment steel plates 51, and a dimension of the second inner edge portion 512a in the circumferential direction of each of the adjustment steel plates 51 is smaller than that of the second outer edge portion 512b. One of the pair of second side edge portions 512c connects one end of the second inner edge portion 512a to one end of the second outer edge portion 512b, and the other of the pair of the second side edge portions 512c connects the other end of the second inner edge portion 512a to the other end of the second outer edge portion 512b. The second fluid flow holes 62 is formed of the second flow holes 512 formed in the adjustment steel plates 51 stacked in the axial direction of the rotary shaft 15.

In each of the adjustment steel plates 51, a dimension N1 from an outer edge portion of each of the adjustment steel plates 51 to the first outer edge portion 511b in the radial direction is greater than a dimension N2 from the outer edge portion of each of the adjustment steel plates 51 to the second outer edge portion 512b in the radial direction. Therefore, in each of the adjustment steel plates 51, a weight of a portion where the two first flow holes 511 are formed is increased as compared to a portion other than the portion where the two first flow holes 511 are formed in the circumferential direction. The portion where the weight is increased forms weight portions 52 in each of the adjustment steel plates 51. The weight portions 52 each are formed at a position where a radial dimension of each of the first flow holes 511 is made smaller than the radial dimension of each of the second flow holes 512 which overlap the balance weight 33 in the axial direction in each of the adjustment steel plates 51. Thus, each of the adjustment steel plates 51 has the weight portions 52 that are formed by reducing the radial dimensions of the first flow holes 511 as compared to the radial dimensions of the second flow holes 512 overlapping the balance weight 33 in the axial direction.

A two-dot chain line in FIG. 4 indicates a case where the second flow holes 512 are formed, instead of the first flow holes 511. It can be said that the first flow holes 511 are formed by closing part of the second flow holes 512. In other words, the first flow holes 511 are formed by increasing the radial dimension of the adjustment steel plate 51 as compared to the second flow holes 512.

Then, the weight portions 52 of the adjustment steel plates 51 are stacked in the axial direction of the entire rotor body 50 to form the balance adjustment portions 58. Thus, the adjustment steel plates 51 have the weight portions 52, and the balance adjustment portions 58 is formed by stacking the weight portions 52 in the entire rotor 24 in the axial direction.

In the adjustment steel plates 51, the weights of the weight portions 52 are adjusted by adjusting the dimensions N1, and hence the radial dimensions of the first flow holes 511, thereby adjusting the weights of the balance adjustment portions 58. The position of the center of gravity of the rotor body 50 is adjusted with the weights of the balance adjustment portions 58 adjusted. As the dimension N1 reduces, the dimension of each of the first flow holes 511 and the first fluid flow holes 61 increases in the radial direction, thereby reducing the weight of each of the weight portions 52, and hence the balance adjustment portions 58. In other words, the smaller the dimension N1, the closer the position of the center of gravity of the rotor body 50 is to the axial line L1. If the dimension N1 is matched with the dimension N2, sizes of all the five fluid flow holes 60 are the same, thereby eliminating the imbalance of each of the adjustment steel plates 51.

On the other hand, as the dimension N1 increases, the dimension of each of the first flow holes 511 and the first fluid flow holes 61 in the radial direction reduces, thereby increasing the weight of each of the weight portion 52, and hence the balance adjustment portions 58. In other words, the larger the dimension N1, the farther the position of the center of gravity of the rotor body 50 is from the axial line L1. Then, by adjusting the position of the center of gravity by adjusting the dimension N1, the balance adjustment relative to the weight of the balance weight 33 is made.

Specifically, the weights of the balance adjustment portions 58 and the position of the center of gravity are adjusted so that the centrifugal force generated by the balance weight 33 can be cancelled by the centrifugal force generated by the balance adjustment portions 58. The weights of the balance adjustment portions 58 and the position of the center of gravity are adjusted by adjusting the dimension N1. A value of the dimension N1 is adjusted in consideration of the weights of the adjustment steel plates 51, the weight of the balance weight 33, the weights of the holding plates 71, the weights of the coupling pins 73, and the weights of the permanent magnets 24a.

As illustrated in FIGS. 2 and 3, each of the pair of holding plates 71 is formed of a metal plate having a disk shape. One of the holding plates 71 is positioned on a first axial end surface of the rotor body 50, and the other of the holding plates 71 is positioned on a second axial end surface of the rotor body 50.

The coupling pins 73 are inserted through the pair of holding plates 71 and the pin holes 50c of the rotor body 50. Then, opposite ends of the coupling pins 73 are riveted, so that the rotor body 50 is held by the pair of holding plates 71. In addition, the permanent magnets 24a are inserted into the magnet holes 50b and bonded to the rotor body 50 with an adhesive.

Each of the holding plates 71 has a through hole 71a that matches the shaft hole 50a of the rotor body 50. Then, the rotary shaft 15 is inserted through the through holes 71a of the holding plates 71 and the shaft hole 50a. Each of the holding plates 71 has five introduction holes 72. Two of the five introduction holes 72 are arranged at positions overlapping the two first fluid flow holes 61, and the other three are arranged at positions overlapping the three second fluid flow holes 62

Each of the introduction holes 72 has an inner edge portion 72a, an outer edge portion 72b, and a pair of side edge portions 72c. The inner edge portion 72a is positioned inside the outer edge portion 72b in the radial direction of each of the holding plates 71, and a dimension of the inner edge portion 72a in the circumferential direction of each of the holding plates 71 is smaller than that of the outer edge portion 72b. One of the pair of side edge portions 72c connects one end of the inner edge portion 72a to one end of the outer edge portion 72b, and the other of the pair of the side edge portions 72c connects the other end of the inner edge portion 72a to the other end of the outer edge portion 72b.

The dimension of the inner edge portion 72a in the circumferential direction of each of the holding plates 71 is the same as that of the first inner arc surface 61a and the second inner arc surface 62a. Further, the dimension of the outer edge portion 72b in the circumferential direction of each of the holding plates 71 is the same as that of the second outer arc surface 62b. A dimension of each of the side edge portions 72c in the radial direction of each of the holding plates 71 is greater than that of each of the first side surfaces 61c and is the same as that of each of the second side surfaces 62c. Therefore, as illustrated in FIG. 3, each of the first fluid flow holes 61 is opened to its associated one of the introduction holes 72 of the holding plates 71 on a radially inward side of each of the holding plates 71. The second fluid flow holes 62 are opened over the entire introduction holes 72.

The introduction holes 72, which overlap the first fluid flow holes 61 and the second fluid flow holes 62, allow the first fluid flow holes 61 and the second fluid flow holes 62 to be opened entirely.

A weight balance of each of the pair of holding plates 71 is uniform in the circumferential and radial directions. Therefore, even when the rotor body 50 is held between the pair of holding plates 71, the weight imbalance by the rotor body 50 is maintained.

The rotary shaft 15 is shrink-fitted to the shaft hole 50a and the through holes 71a, so that the rotor 24 and the rotary shaft 15 are integrated. The position of the rotor body 50 is determined relative to the rotary shaft 15 such that the first fluid flow holes 61 of the rotor body 50 are positioned on a side opposite from the balance weight 33 across the axial line L1.

### Operation of Embodiment

The following will describe the operation of the present embodiment.

When the scroll electric compressor 10 operates, the centrifugal force generated by orbital motion of the orbiting scroll 28 acts on the rotary shaft 15. On the other hand, the balance weight 33 is formed integrally with the rotary shaft 15. As a result, when the scroll electric compressor 10 operates, the centrifugal force generated by the balance weight 33 acts on the rotary shaft 15. Furthermore, the rotor 24 has the balance adjustment portions 58 provided in the rotor body 50. Thus, when the scroll electric compressor 10 operates, the centrifugal force generated by the balance adjustment portions 58 also acts on the rotary shaft 15 through the rotor 24. As a result, the scroll electric compressor 10 cancels the centrifugal force generated by the orbiting scroll 28 acting on the rotary shaft 15 with the centrifugal force generated by the balance weight 33 and the centrifugal force generated by the balance adjustment portions 58.

### Effects of the First Embodiment

The first embodiment offers the following advantageous effects.
(1-1) In the rotor body 50, the weights of the weight portions 52 are adjusted by adjusting the radial dimensions of the first flow holes 511 of the adjustment steel plates 51, so that the balance adjustment portions 58 can be provided in the rotor 24 in which the adjustment steel plates 51 are stacked. In other words, balance adjustment of the rotor 24 by the balance adjustment portions 58 can be made only by adjusting the radial dimensions in the adjustment steel plates 51. Therefore, the balance adjustment of the rotor 24 can be made without providing an additional part such as a weight on the rotor 24. Therefore, the number of parts of the rotor 24 can be reduced and the rotor 24 can be made smaller in the axial direction as compared with a case where an additional part is added to the end face of the rotor 24 in the axial direction to adjust the balance of the rotor 24.
(1-2) The balance adjustment portions 58 are formed in the rotor 24 by forming the first fluid flow holes 61 and the second fluid flow holes 62, which are different in dimension in the radial direction, in the rotor body 50. In other words, the balance adjustment portions 58 are formed in the rotor body 50 by providing the weight portions 52 of the adjustment steel plates 51 in portions where the second fluid flow holes 62 should be formed. Therefore, the balance adjustment portions 58 may be formed by effectively utilizing potions to be discarded if the second fluid flow holes 62 are formed in place of the first fluid flow holes 61. Accordingly, the scroll electric compressor 10 can reduce the number of parts of the rotor 24 while improving the material yield of the rotor 24, and also can reduce the size of the rotor 24 in the axial direction.
(1-3) The first fluid flow holes 61 each are a hole through which refrigerant flows while refrigerant is drawn into the compression part 25. In the scroll electric compressor 10, the balance adjustment portions 58 may be provided in the rotor 24 by adjusting the dimensions of the first fluid flow holes 61, that is, adjusting the radial dimensions of the first flow holes 511. Accordingly, in the scroll electric compressor 10, the centrifugal force of the orbiting scroll 28 acting on the rotary shaft 15 may be suitably cancelled by effectively utilizing the existing configuration.
(1-4) The first fluid flow holes 61 are arranged, along with the second fluid flow holes 62, on the first imaginary circle C1. Thus, the first fluid flow holes 61 are positioned close to the shaft hole 50a in the radial direction of the rotor body 50. When the rotor body 50 is integrated with the rotary shaft 15 by shrink-fitting, the rotor body 50 is heated. At this time, the rotor body 50 expands easily in the radial direction of the rotor 24 due to the presence of the fluid flow holes 60 including the first fluid flow holes 61. Therefore, even when the radial dimensions of the first fluid flow holes 61 are made smaller than those of the second fluid flow holes 62, the rotor 24 and the rotary shaft 15 are easily integrated using the first fluid flow holes 61.
(1-5) The balance adjustment portions 58 are provided over the entire rotor 24 in the axial direction thereof. Since the weight balance of the rotor 24 may be made constant in the axial direction, the rotor 24 with the adjusted balance can be easily manufactured.

### Second Embodiment

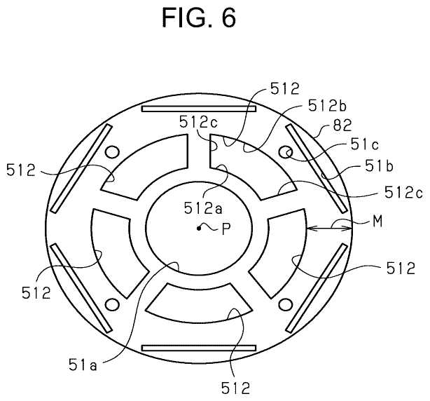

The following will describe a scroll electric compressor according to a second embodiment with reference to FIGS. 5 and 6. The configuration of the second embodiment only differs in the rotor body 50 of the first embodiment, and, therefore, the detailed description of the same parts is omitted.

As illustrated in FIG. 5, the rotor body 50 is formed by stacking a plurality of adjustment steel plates 51 of the first embodiment and a plurality of stacking steel plates 82 that are different from the adjustment steel plates 51. A radial direction of the stacking steel plates 82 corresponds to that of the rotary shaft 15.

As illustrated in FIG. 6, the stacking steel plates 82 each have five second flow holes 512 as in each of the adjustment steel plates 51. The five second flow holes 512 are arranged at regular intervals in a circumferential direction of each of the stacking steel plates 82. In addition, a dimension M from an outer edge portion of each of the stacking steel plates 82 to the second outer edge portion 512b in the radial direction is the same as the dimension N2 from the outer edge portion of each of the adjustment steel plates 51 to the second outer edge portion 512b in the radial direction. The dimensions M corresponding to dimensions outside the five second flow holes 512 in the radial direction are all the same. Therefore, the stacking steel plates 82 have no weight portion 52. The center of gravity of each of the stacking steel plates 82 is positioned on a center P of each of the stacking steel plates 82.

As illustrated in FIG. 5, the rotor body 50 is formed by stacking the plurality of adjustment steel plates 51 and the plurality of stacking steel plates 82 in the axial direction. The adjustment steel plates 51 are stacked from the first axial end surface to a portion of the rotor body 50 on the second axial end surface side relative to the center in the axial direction. The stacking steel plates 82 are stacked from the portion of the rotor body 50 on the second axial end surface side relative to the center in the axial direction to the second axial end surface.

The fluid flow holes 60 includes a third fluid flow holes 63 formed by the first flow holes 511 of the adjustment steel plates 51 and the second flow holes 512 of the stacking steel plates 82, and the second fluid flow holes 62 formed by the second flow holes 512 of the adjustment steel plates 51 and the second flow holes 512 of the stacking steel plates 82.

Therefore, in the rotor body 50, the balance adjustment portions 58 are provided by the weight portions 52 in portions of the rotor body 50 where the adjustment steel plates 51 are stacked, and the weight of the portion of the rotor body 50 where the adjustment steel plates 51 are stacked is increased by a portion where the stacking steel plates 82 are stacked. Therefore, the balance of weight of the rotor body 50 is different in both the axial direction and the circumferential direction. The balance adjustment portions 58 are provided by stacking the weight portions 52 in a portion of the rotor 24 in the axial direction thereof.

### Effects of Second Embodiment

The second embodiment offers the following advantageous effects, in addition to (1-1) to (1-4) of the first embodiment.
(2-1) The balance adjustment portions 58 are provided in a portion of the rotor 24 in the axial direction. Therefore, the balance of the weight of the rotor 24 may be varied in the axial direction. As a result, the balance adjustment by the rotor 24 can be broadened.
(2-2) The rotor body 50 is formed by combining the adjustment steel plates 51 and the stacking steel plates 82. Since the stacking steel plates 82 each have the five second flow holes 512 at regular intervals in the circumferential direction, the stacking steel plates 82 have no weight portion 52. That is, the stacking steel plates 82 each are an existing steel plate used to manufacture the rotor 24 without the balance adjustment portion 58. Therefore, the balance of the weight of the rotor 24 can be adjusted by combining the existing stacking steel plates 82 and the adjustment steel plates 51.

### Modification

The present embodiments may be modified in various manners, as exemplified below. The above-described embodiments and modifications may be combined within the scope consistent with the present disclosure.

A steel plate other than the adjustment steel plates 51 and the stacking steel plates 82 may be used for forming the rotor body 50. In short, various types of stacking steel plates may be used by adjusting the dimensions of the fluid flow holes 60 in the radial direction as long as the balance adjustment portions 58 are provided in the rotor 24.

The number of fluid flow holes 60 may be two, three, four, or six or more. When the number of the fluid flow holes 60 is three or more, the number of the flow holes whose radial dimension is smaller than that of the flow holes overlapping the balance weight 33 may also be changed accordingly while the number of the flow holes overlapping the balance weight 33 in the axial direction is changed as appropriate, for example, one or two.

For example, if two fluid flow holes 60 are provided, each of the fluid flow holes 60 has an elongated hole shape extending in a semicircular arc shape in the axial view of the rotor body 50. In this case, a radial dimension of a hole that forms one of the fluid flow holes 60 is made smaller than that of a hole that forms the other of the fluid flow holes 60 overlapping the balance weight 33 in the axial direction to form the weight portion 52. Then, the weight portions 52 may be stacked in the axial direction to provide the balance adjustment portions 58.

In the first embodiment, the number of the first fluid flow holes 61 formed of the first flow holes 511 and the number of the second fluid flow holes 62 formed of the second flow holes 512 may be appropriately changed according to the size and weight of the balance weight 33. For example, the rotor body 50 may include two first fluid flow holes 61, and one second fluid flow hole 62.

Similarly, in the second embodiment, the number of the third fluid flow holes 63 formed of the first flow holes 511 and the second flow holes 512, and the number of the second fluid flow holes 62 may be appropriately changed according to the size and weight of the balance weight 33. For example, the rotor body 50 may have two third fluid flow holes 63 and one second fluid flow hole 62.

In the rotor 24, the balance adjustment portions 58 may be formed in the rotor 24 by making the dimension of the fluid flow holes 60 in the radial direction zero.

The first fluid flow holes 61 may be formed with the first outer arc surface 61b positioned on the second imaginary circle C2. Even in this case, the weight portions 52 each are formed at a position where the radial dimension of each of the 10 first flow holes 511 is smaller than the radial dimension of each of the second flow holes 512 which overlaps the balance weight 33 in the axial direction.

Fluid may be gases other than refrigerant, for example, air, hydrogen, and nitrogen.

What is claimed is:

1. A scroll electric compressor comprising:
a rotary shaft;
a motor including a rotor fixed to the rotary shaft, and a stator having a cylindrical shape and surrounding the rotor;
a compression part configured to compress fluid with rotation of the rotary shaft;
a housing accommodating the motor and the compression part;
the compression part including a fixed scroll and an orbiting scroll configured to make orbital motion with the rotation of the rotary shaft, disposed in the housing, the fixed scroll and the orbiting scroll cooperating to form a compression chamber in which the fluid is compressed;
the housing having a motor housing accommodating the motor, a compression part housing accommodating the compression part, a shaft support housing rotatably supporting the rotary shaft between the rotor and the orbiting scroll;
a balance weight being fixed to the rotary shaft, extending in a radial direction of the rotary shaft, and facing the rotor and the shaft support housing in an axial direction of the rotary shaft,
a plurality of stacking steel plates being stacked in the axial direction to form the rotor;
the rotor having a plurality of fluid flow holes through which the fluid flows, the fluid flow holes being disposed in a circumferential direction of the rotor and extending though the rotor in the axial direction; and
the stacking steel plates each having a plurality of flow holes, the stacking steel plates being stacked so that the flow holes form the fluid flow holes, wherein
the rotor has a balance adjustment portion at a position where the balance adjustment portion cancels a centrifugal force generated by the balance weight, and
the stacking steel plates have weight portions, respectively, that are formed by reducing a radial dimension of at least one of the flow holes as compared to a radial dimension of the other of the flow holes that overlaps the balance weight in the axial direction, and the balance adjustment portion is formed by stacking the weight portions in the axial direction.

2. The scroll electric compressor according to claim 1, wherein
the rotor is integrated into the rotary shaft by shrink-fitting, and
the fluid flow holes each have an elongated hole shape extending in an arc shape in the circumferential direction of the rotor, radially inner surfaces of the fluid flow holes each extend along an imaginary circle extending in the circumferential direction with an axial line of the rotary shaft as a center, at least one of the fluid flow holes disposed inside the balance adjustment portion in the radial direction has a radially outer surface that is positioned inside relative to a radially outer surface of the other of the fluid flow holes, in the radial direction, that overlaps the balance weight in the axial direction.

3. The scroll electric compressor according to claim 1, wherein
the balance adjustment portion is formed by stacking the weight portions in the entire rotor in the axial direction.

4. The scroll electric compressor according to claim 1, wherein
the balance adjustment portion is formed by stacking the weight portions in a portion of the rotor in the axial direction.
